(19) United States
(12) Patent Application Publication
(10) Pub. No.: US 2026/0053117 A1
(43) Pub. Date: Feb. 26, 2026

(54) BIRD FEEDER

(71) Applicant: Netvue Technologies Co., Ltd., Shenzhen (CN)

(72) Inventor: Youle Hu, Shenzhen (CN)

(21) Appl. No.: 19/304,591

(22) Filed: Aug. 19, 2025

(30) Foreign Application Priority Data
Aug. 20, 2024 (CN) 202411147798.2
Aug. 20, 2024 (CN) 202422023613.9
Aug. 20, 2024 (CN) 202422025699.9
Aug. 20, 2024 (CN) 202422026228.X
Aug. 20, 2024 (CN) 202422026603.0

(51) Int. Cl. A01K 31/12; A01K 39/012; G03B 29/00

(52) U.S. Cl. CPC A01K 39/012; A01K 31/12; G03B 29/00

(57) ABSTRACT

A bird feeder includes a main body and a first shooting device. The main body includes a feeding tray and a vacant area is formed between the first shooting device and the feeding tray and prevents birds from perching between the first shooting device and the feeding tray. The presence of the vacant area between the first shooting device and the feeding tray ensures that no position is available for the birds to perch between the first shooting device and the feeding tray, forcing the birds to stand only at a side of the feeding tray away from the first shooting device to feed, and keeping the birds within an optimal focusing range, thereby improving the imaging quality.

### CROSS-REFERENCE TO RELATED APPLICATIONS

This application claims priority to Chinese Patent Applications No. 202411147798.2, No. 202422025699.9, No. 202422026603.0, No. 202422026228.X, and No. 202422023613.9, all filed on Aug. 20, 2024. The disclosures of the above-mentioned applications are incorporated by reference in their entireties.

### TECHNICAL FIELD

The present disclosure relates to the technical field of animal feeding devices, and in particular, to a bird feeder.

### BACKGROUND

With the continuous improvement of people's environmental awareness and cultural literacy, some people, driven by hobbies, kindness, research or other purposes, choose to feed birds. A common feeding method is to set up a bird feeder and wait for the birds to fly over and feed. To carefully observe the habits of the birds, some bird feeders are equipped with shooting devices. However, in actual use, birds sometimes may perch between a feeding tray and the shooting device of the bird feeder and eat, which may easily lead to inaccurate focusing of the shooting device, resulting in blurry images and seriously affecting the imaging quality.

### SUMMARY

The present disclosure relates to a bird feeder with a shooting device. The bird feeder includes a main body and a first shooting device, where the main body includes a feeding tray, and a vacant area is formed between the first shooting device and the feeding tray and prevents birds from perching between the first shooting device and the feeding tray.

### BRIEF DESCRIPTION OF THE DRAWINGS

FIG. 1 is a first schematic structural diagram of an overall structure of a bird feeder.

FIG. 2 is a second schematic structural diagram of an overall structure of a bird feeder.

FIG. 3 is a schematic structural diagram of a bird feeder with a bin lid hidden.

FIG. 4 is a side view of a bird feeder.

FIG. 5 is a schematic structural diagram of a fixing bracket.

FIG. 6 is a schematic structural diagram of a partial structure of a bird feeder.

FIG. 7 is third schematic structural diagram of an overall structure of a bird feeder.

FIG. 8 is a sectional view of a partial area of a bird feeder.

FIG. 9 is a first schematic structural diagram of an expansion plate.

FIG. 10 is a second schematic structural diagram of an expansion plate.

### DETAILED DESCRIPTION OF THE EMBODIMENTS

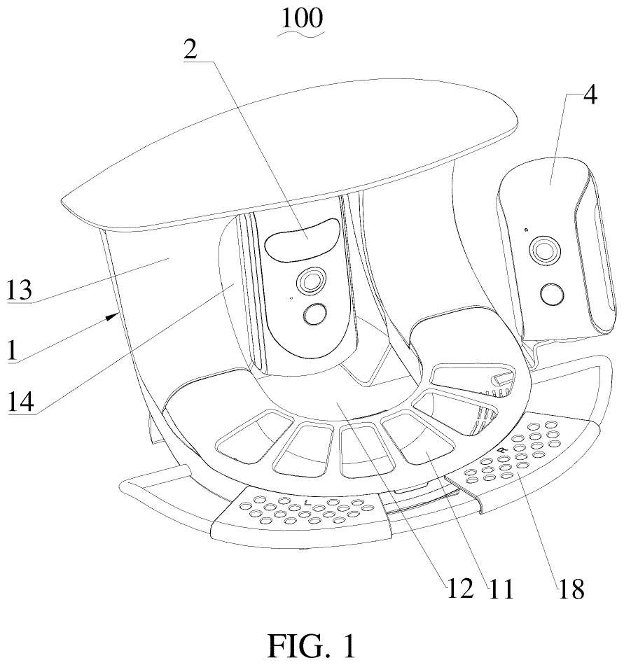

Referring to FIG. 1 to FIG. 3, a bird feeder 100 includes a main body 1 and a first shooting device 2, where the main body 1 includes a feeding tray 11, and a vacant area 12 is formed between the first shooting device 2 and the feeding tray 11 and prevents birds from perching between the first shooting device 2 and the feeding tray 11.

The presence of the vacant area 12 between the first shooting device 2 and the feeding tray 11 ensures that no position is available for the birds to perch between the first shooting device 2 and the feeding tray 11, forcing the birds stand only at a side of the feeding tray 11 away from the first shooting device 2 to feed, keeping the birds within an optimal focusing range of the first shooting device 2, avoiding the problem of blurry images caused by inaccurate focusing of the first shooting device 2, thereby effectively improving the imaging quality, and enhancing the use experience of a user.

Referring to FIG. 1 to FIG. 3, the feeding tray 11 is U-shaped, and the vacant area 12 is located at an inner side of the feeding tray 11.

On the premise that the area for birds to feed is fixed, the U-shaped feeding tray 11 may allow more birds to feed simultaneously. Moreover, an inner-side area of the U-shaped feeding tray 11 may serve as the vacant area 12, helping to simplify an overall structure of the bird feeder.

Referring to FIG. 1 to FIG. 3, the main body 1 further includes a feed bin 13 connected with the feeding tray 11, and the feed bin 13 and the feeding tray 11 enclose the vacant area 12.

The feed bin 13 and the feeding tray 11 enclose the vacant area 12, further simplifying the overall structure of the bird feeder, and making the bird feeder appear simpler.

Referring to FIG. 1 to FIG. 3, the feed bin 13 is provided with an avoidance area 14 for accommodating the first shooting device 2.

The arrangement of the avoidance area 14 is equivalent to a separate installation area within a space originally occupied by the feed bin 13 for installing the first shooting device 2. This allows the overall volume of the bird feeder to be kept relatively small, making it easier for a user to place the bird feeder in an environment with more confined space. Meanwhile, the feed bin 13 may play a role in protecting the first shooting device 2 to a certain extent.

Referring to FIG. 1 to FIG. 3, the avoidance area 14 runs through a front side and a rear side of the feed bin 13.

The avoidance area 14 running through the front side and the rear side of the feed bin 13 allows the user to disassemble and assemble the first shooting device 2 from either the front side or the rear side of the feed bin 13, facilitating the disassembly and assembly and the later maintenance of the first shooting device 2. Meanwhile, the overall structure of the bird feeder becomes more novel and simpler.

Referring to FIG. 1 to FIG. 3, a bottom of the avoidance area 14 is communicated with the vacant area 12.

The bottom of the avoidance area 14 communicating with the vacant area 12 simplifies the overall structure of the main body 1 to a greater extent, making the processing and manufacturing of the main body 1 more convenient.

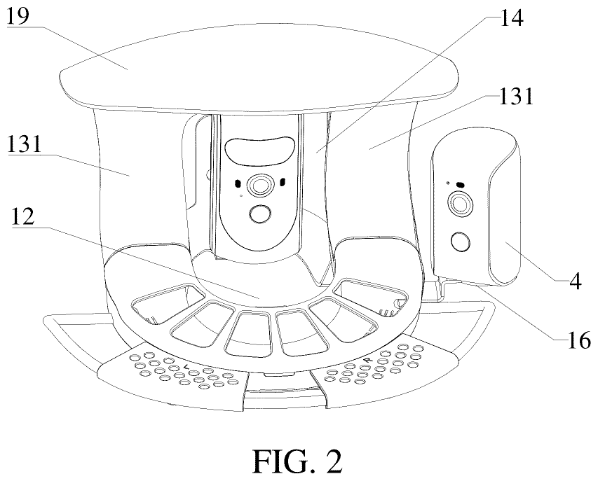

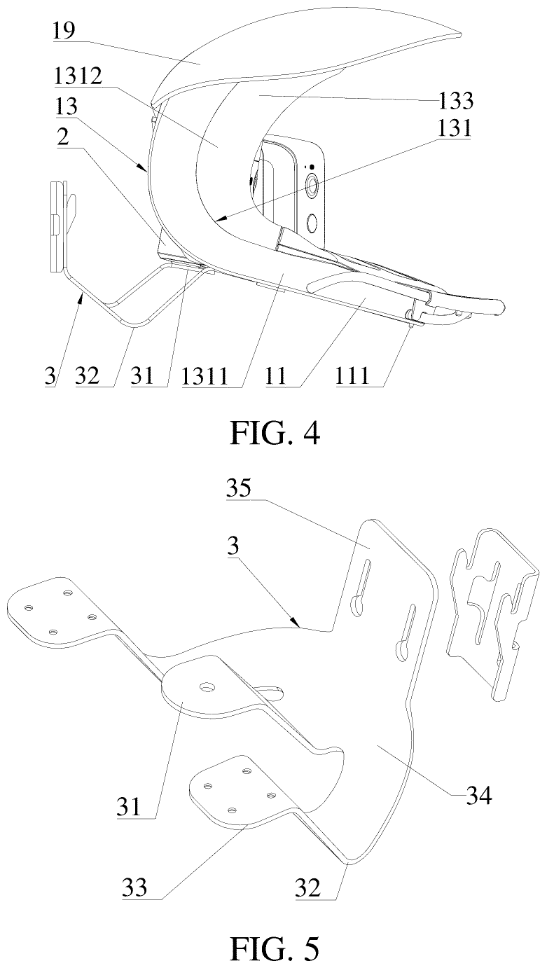

Referring to FIG. 2 and FIG. 4, the feed bin 13 is provided with feed channels 131, both ends of the feeding tray 11 are respectively connected to the feed channels 131, and the feeding tray 11 and the two feed channels 131 enclose the avoidance area 14 and the vacant area 12.

The avoidance area 14 and the vacant area 12 are simple to form, making the assembly and manufacturing of the bird feeder easier.

Referring to FIG. 2 and FIG. 4, the feed bin 13 is provided with a storage portion 133 communicated with the feed channels 131, and the storage portion 133 is located above the avoidance area 14.

The user can simply place feed into the storage portion 133, the feed may be delivered to the feeding tray 11 through the two feed channels 131 respectively, making the feeding process simple, smooth and efficient.

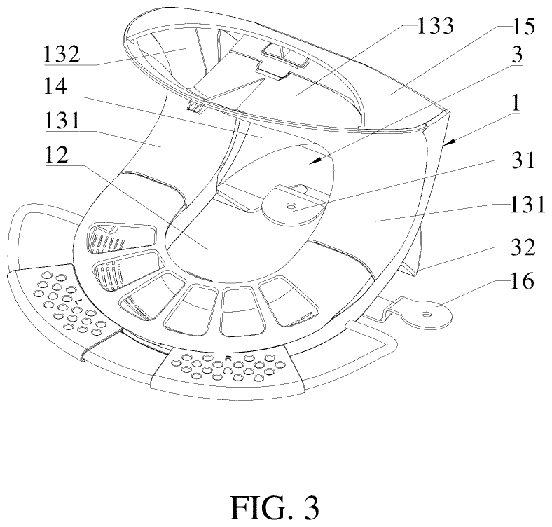

Referring to FIG. 3 and FIG. 5, the bird feeder further includes a fixing bracket 3 connected with the main body 1, where the fixing bracket 3 is provided with a fixing plate 31 extending into the avoidance area 14, and the first shooting device 2 is installed on the fixing plate 31.

Installing the first shooting device 2 on the fixing plate 31 enables the first shooting device 2 to be supported more stably, and facilitates the disassembly and assembly of the first shooting device 2.

Referring to FIG. 3 to FIG. 5, the fixing bracket 3 further includes legs 32 connected with the fixing plate 31, the legs 32 are connected with the main body 1 and cause the feed bin 13 and the feeding tray 11 to be inclined, and a support portion 111 is formed at the bottom of an area of the feeding tray 11 away from the first shooting device 2.

The inclined feed bin 13 and feeding tray 11 can reduce a phenomenon of feed accumulation at a connection between the feeding tray 11 and the feed bin 13, ensuring that the feed is better dispersed in the feeding tray 11 for birds to eat.

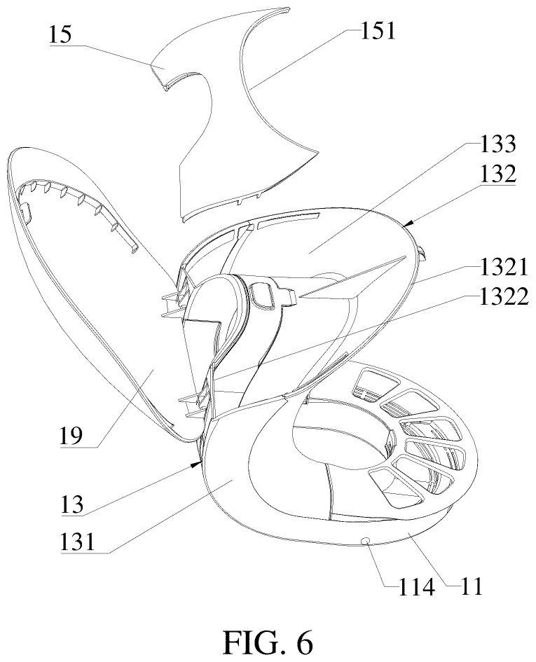

Referring to FIG. 3 and FIG. 6, an opening 132 is formed in the top of the feed bin 13, the opening 132 of the feed bin 13 is inclined, the opening 132 is has a first side 1321 and a second side 1322 away from the first side 1321, and the first side 1321 is arranged higher than the second side 1322.

The opening 132 has a large area, which is convenient for the user to clean the interior of the feed bin 13 through the opening 132.

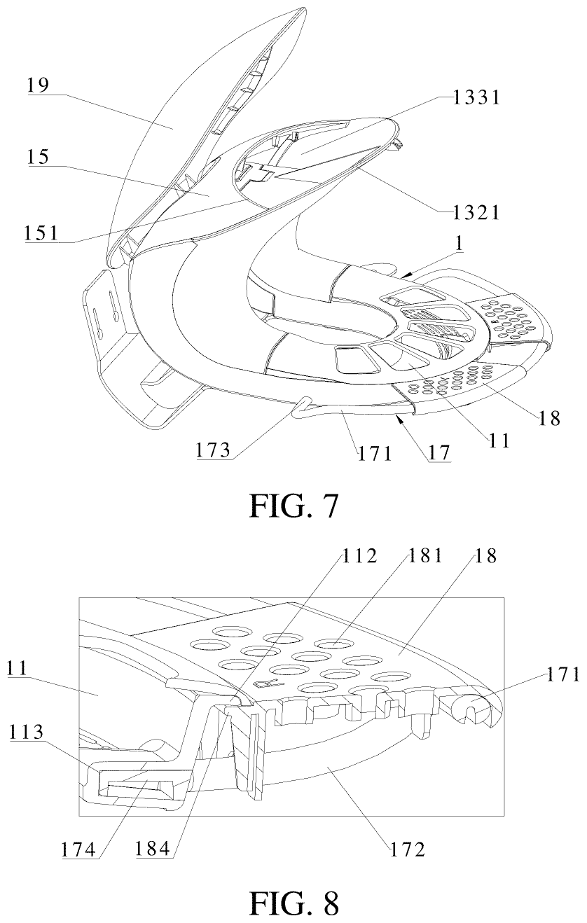

Referring to FIG. 3, FIG. 6 and FIG. 7, a detachable stop plate 15 is provided at the opening 132 of the feed bin 13, the stop plate 15 covers an area of the opening 132 close to the second side 1322, and an edge of the stop plate 15 close to the first side 1321 and the first side 1321 enclose a feed inlet 1331.

The arrangement of the stop plate 15 can increase the storage capacity of the feed bin 13, reducing the frequency of adding feed into the feed bin 13 by the user, thereby enhancing the use experience of the user.

Referring to FIG. 6 and FIG. 7, a notch is formed in an area of the stop plate 15 away from the second side 1322.

The provision of the notch 151 can enlarge the area of the feed inlet 1331, which is convenient for the user to add feed to the feed bin 13.

Referring to FIG. 2, FIG. 6 and FIG. 7, the bird feeder further includes a bin lid 19 rotatably connected with the feed bin 13, where the bin lid 19 is shell-shaped.

The shell-shaped bin lid 19 has good self-cleaning capability, allowing rainwater carrying dust and other impurities to quickly run off along an outer surface of the bin lid 19.

Referring to FIG. 7 and FIG. 8, the main body 1 further includes a perching frame 17. The perching frame 17 is located at a front side of the feeding tray 11 and provided with an expansion plate 18, and a plurality of installation holes 181 are formed in the expansion plate 18.

The expansion plate 18 can expand the functions of the bird feeder, so that the bird feeder can feed a variety of birds. The installation holes 181 in the expansion plate 18 are configured to detachably install feeding devices, which include, but are not limited to, honey pots, fixing spikes, food cages and the like.

Referring to FIG. 6 to FIG. 8, the expansion plate 18 is detachably connected with the perching frame 17.

After the user removes the expansion plate 18, the perching frame 17 can accommodate a larger number of birds to feed simultaneously. Meanwhile, the expansion plate 18 is detachable, which is convenient for the user to clean the expansion plate 18 thoroughly.

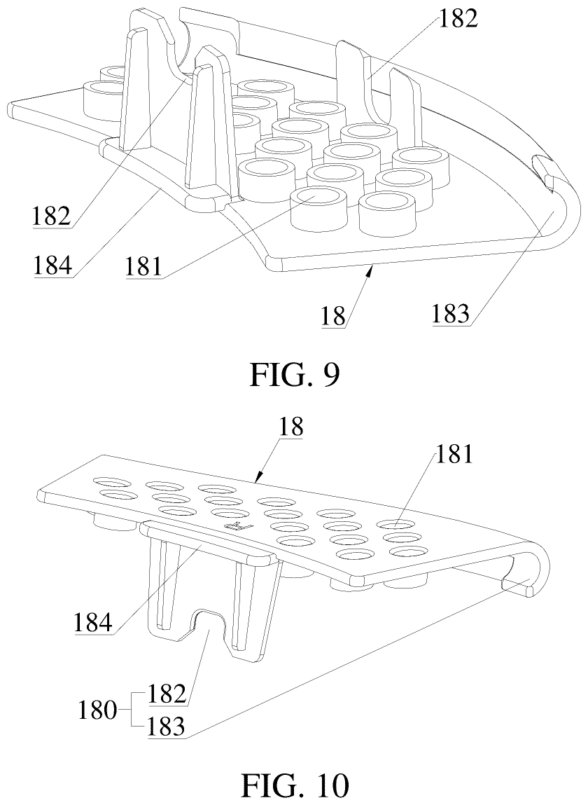

Referring to FIG. 7 to FIG. 10, the expansion plate 18 is detachably placed on the perching frame 17. The expansion plate 18 is provided with a limiting structure 180 matched with the perching frame 17 in a limiting manner, the perching frame 17 includes an arc-shaped rib 171 and a connecting rib 172, the connecting rib 172 is located below the arc-shaped rib 171, one end of the connecting rib 172 is connected to the arc-shaped rib 171, and the other end of the connecting rib 172 is connected to the main body 1. The limiting structure 180 includes a first limiting groove 182 matched with the connecting rib 172 and a second limiting groove 183 matched with the arc-shaped rib 171, and the second limiting groove 183 is formed by bending and extending an outer edge of the expansion plate 181 downward and inward. The connecting rib 172 is arc-shaped, and one end of the connecting rib 172 connected to the arc-shaped rib 171 is arranged higher than the other end of the connecting rib. One side of the expansion plate 18 close to the feeding tray 11 is provided with a first edge 184 protruding toward the direction of the main body 1, an area of the feeding tray 11 close to the expansion plate 18 is provided with a second edge 112 protruding outward, and the first edge 184 is located below the second edge 112.

When removing the expansion plate 18 from the perching frame 17 is needed, the user needs to move the expansion plate 18 in a direction away from the feeding tray 11 for a short distance, so that the first edge 184 exits the area below the second edge 112, and then the expansion plate 18 can be removed. In this way, the risk of the expansion plate 18 unintentionally detached from the perching frame 17 can be greatly reduced.

Referring to FIG. 1 and FIG. 2, the first shooting device 2 is a Pan-tilt-zoom (PTZ)-fixed linkage camera.

The first shooting device 2 has a wide-angle camera and a narrow-angle camera, where the wide-angle camera is arranged on a gun, and the narrow-angle camera is arranged on a ball. The narrow-angle camera on the ball is capable of vertical tilt adjustment and/or horizontal rotation adjustment. The wide-angle camera is configured to quickly identify target birds of interest, and the narrow-angle camera is configured to capture high-definition magnified images of the target birds of interest. By using the PTZ-fixed linkage camera as the first shooting device 2, images that are of greater interest to the user may be captured, enhancing the use experience of the user.

Referring to FIG. 1 and FIG. 2, a distance between the first shooting device 2 and the feeding tray 11 is greater than or equal to 80 mm in a shooting direction of the first shooting device 2.

The distance between the first shooting device 2 and the feeding tray 11 being greater than or equal to 80 mm can ensure that the first shooting device 2 has a sufficient object distance, thereby improving the shooting and imaging quality.

Referring to FIG. 1 to FIG. 3, the bird feeder further includes a second shooting device 4. The second shooting device 4 is arranged at a side of the feeding tray 11 and shoots from the side of the feeding tray 11 towards the feeding tray 11.

The second shooting device 4 assists the first shooting device 2 from the side, helping to improve the accuracy of identifying the target birds of interest.

Referring to FIG. 1, a bird feeder 100 includes a main body 1 and a first shooting device 2, where the main body 1 includes a feed bin 13 and a feeding tray 11 which are connected, and a vacant area 12 is formed between the first shooting device 2 and the feeding tray 11 and prevents birds from perching between the first shooting device 2 and the feeding tray 11, meaning that the birds can only stand at a position of the feeding tray 11 away from the vacant area 12 to feed. In some embodiments, the feeding tray 11 is U-shaped. In this case, the vacant area 12 is located at an inner side of the feeding tray 11, with a concave area of the feeding tray 11 forming the vacant area 12.

In one or more embodiments, the feed bin 13 and the feeding tray 11 enclose the vacant area 12. In this case, the vacant area 12 is naturally formed once the bird feeder is assembled.

In conjunction with FIG. 1 to FIG. 3, the feed bin 13 is configured to store feed. When the feed in the feeding tray 11 is insufficient, the feed in the feeding tray 11 cannot effectively support the feed in the feed bin 13, and under the effect of gravity, the feed in the feed bin 13 automatically flows into the feeding tray 11 for replenishment. In some embodiments, the feed bin 13 is provided with an avoidance area 14 for accommodating the first shooting device 2. The avoidance area 14 not only facilitates the user in installing the first shooting device 2, but also allows the feed bin 13 to play a role in protecting the first shooting device 2 to a certain extent.

In some embodiments, the avoidance area 14 is a window provided at the front side of the feed bin 13. In this case, the first shooting device 2 is installed in the window. However, in other embodiments, the avoidance area 14 runs through the front side and the rear side of the feed bin 13, so that the feed bin 13 has a cavity for placing the first shooting device 2. The cavity may allow light to pass through, thereby reducing the influence of the bird feeder on the visual observation angle of the user from the rear side of the feed bin 13.

In some embodiments, the bottom of the avoidance g area 14 is communicated with the vacant area 12. The feed bin 13 is provided with feed channels 131, both ends of the feeding tray 11 are respectively connected to the feed channels 131, and the feeding tray 11 and the two feed channels 131 enclose the avoidance area 14 and the vacant area 12. The avoidance area 14 is located between the two feed channels 131, and a gap between the two feed channels 131 forms an effect of running through the front side and rear side of the feed bin 13.

In conjunction with FIG. 3 to FIG. 5, the bird feeder further includes a fixing bracket 3 connected with the main body 1, where the fixing bracket 3 is provided with a fixing plate 31 extending into the avoidance area 14, and the first shooting device 2 is installed on the fixing plate 31. To facilitate the later maintenance of the first shooting device 2, the first shooting device 2 is detachably connected with the fixing plate 31, such as by screw connection and snap connection. In other embodiments, when the avoidance area 14 does not run through the front side and rear side of the feed bin 13, the first shooting device 2 is directly installed on the feed bin 13.

To allow for smooth feed dispensing of the bird feeder, the fixing bracket 3 further includes legs 32 connected with the fixing plate 31, the legs 32 are connected with the main body 1 and cause the feed bin 13 and the feeding tray 11 to be inclined, and a support portion 111 is formed at the bottom of an area of the feeding tray 11 away from the first shooting device 2. In some embodiments, as shown in FIG. 4, due to the inclination of the feed bin 13, an inclined channel 1311 is formed in an area where the feed bin 13 is connected with the feeding tray 11, the inclined channel 1311 is directly communicated with the feeding tray 11, and one end of the inclined channel 1311 connected to the feeding tray 11 is arranged lower than one end of the inclined channel 1311 away from the feeding tray 11. In this way, the feed in the feed bin 13 may fall into the feeding tray 11 smoothly. Meanwhile, due to the inclination of the inclined channel 1311, it is difficult for birds to stand on, ensuring that the feeding birds do not perch on the inclined channel 1311, which helps maintain the shooting quality of the first shooting device 2.

In conjunction with FIG. 3 to FIG. 5, the fixing bracket 3 includes heightening portions 33 connected with the legs 32. The heightening portions 33 are fixedly connected with the inclined channel 1311, located below one end of the inclined channel 1311 away from the feeding tray 11, and enable the inclined channel 1311 to remain in an inclined state. In some embodiments, the heightening portions 33 and the inclined channel 1311 are formed as a unified structure through integrated processing. However, in this embodiment, the heightening portions 33 and the inclined channel 1311 are fixedly connected by a fastening structure. The fastening structure includes, but is not limited to, a hot melt pillar, a screw, etc. When the bird feeder is placed flat on a platform surface, the support legs 32 and the support portion 111 simultaneously come into contact with the platform surface, thereby enabling the inclined channel 1311 and the feeding tray 11 to remain in an inclined state simultaneously.

In some embodiments, the fixing bracket 3 further includes a connecting portion 34 and a hanging plate 35. The connecting portion 34 is connected with the hanging plate 35, the fixing plate 31 and the legs 32 respectively. To ensure the structural strength of the fixing bracket 3, the fixing bracket 3 may be made of metal material, such as iron alloy and aluminum alloy. The bird feeder may be mounted on a wall, a tree and other external components through the hanging plate 35. Therefore, the bird feeder offers a variety of installation methods and high installation flexibility.

In conjunction with FIG. 3 and FIG. 4, in one or more embodiments, the main body 1 looks like a bent O-shaped structure on the whole. Specifically, as shown in FIG. 4, the feed channel 131 further includes an arc-shaped channel 1312, where one end of the inclined channel 1311 away from the feeding tray 11 is communicated with the arc-shaped channel 1312. In this embodiment, the feed channel 131 is C-shaped on the whole, and the C-shaped feed channel 131 allows the feed to flow smoothly and reduce the phenomenon of feed blockage. Especially, the presence of the heightening portions 33 of the fixing bracket 3 makes the feed channel 131 have a certain degree of inclination, which further greatly enhances the smoothness of feed delivery through the feed channel 131.

The feed bin 13 is provided with a storage portion 133 communicated with the feed channels 131, and the storage portion 133 is located above the avoidance area 14. The tops of the two feed channels 131 intersect to form the storage portion 133. As shown in FIG. 3, FIG. 4, FIG. 6 and FIG. 7, an opening 132 communicating the feed bin 13 with the outside is formed in the top of the feed bin 13, and t he opening 132 of the feed bin 13 is inclined. The opening 132 has a first side 1321 and a second side 1322 away from the first side 1321, and the first side 1321 is arranged higher than the second side 1322. A stop plate 15 is provided at the opening 132 of the feed bin 13 and covers an area of the opening 132 close to the second side 1322, and an edge of the stop plate 15 close to the first side 1321 and the first side 1321 enclose a feed inlet 1331.

In some embodiments, the stop plate 15 is non-detachably connected with the feed bin 13, thereby reducing the risks of the stop plate 15 being lost. However, to facilitate cleaning of the bird feeder, the stop plate 15 is detachably connected with the feed bin 13. Specifically, the stop plate 15 is connected with the feed bin 13 via snap-fit connection, magnetic connection or limiting connection.

To enlarge the area of the feed inlet 1331 for the user to add the feed into the feed bin 13, a notch 151 is formed in an area of the stop plate 15 away from the second side 1322. In some embodiments, the notch 151 is arc-shaped.

In conjunction with FIG. 2, FIG. 4, FIG. 6 and FIG. 7, the bird feeder further includes a bin lid 19 rotatably connected with the feed bin 13, where the bin lid 19 is shell-shaped. As shown in FIG. 6, the connection between the bin lid 19 and the feed bin 13 is provided close to the second side 1322. For the shell-shaped bin lid 19, the opening 132 at the top of the feed bin 13 is more likely to present a phenomenon where the first side 1321 is higher than the second side 1322. In this case, the arrangement of the stop plate 15 becomes more necessary.

In conjunction with FIG. 1 and FIG. 2, a shooting angle of the first shooting device 2 directly faces the feeding tray 11, allowing the first shooting device 2 to fully capture images of birds feeding in the feeding tray 11. In some embodiments, the first shooting device 2 is a PTZ-fixed linkage camera. A distance between the first shooting device 2 and the feeding tray 11 is greater than or equal to 80 mm in a shooting direction of the first shooting device 2, thereby ensuring that the first shooting device 2 has a sufficient object distance to ensure the shooting and imaging quality.

In conjunction with FIG. 1 to FIG. 3, to achieve multi-angle shooting, the main body 1 of this bird feeder is connected with a support arm 16, the support arm 16 is provided with a second shooting device 4, and the second shooting device 4 is located at the side of the feeding tray 11. A shooting direction of the second shooting device 4 faces the feeding tray 11, meaning that the second shooting device 4 captures from the side of the feeding tray 11 towards the feeding tray 11. The second shooting device 4 may assist the first shooting device 2 from the side to improve the accuracy of identifying target birds of interest. In some embodiments, the fixing bracket 3 and the support arm 16 are formed as a unified structure through integrated processing. In other embodiments, the fixing bracket 3 and the support arm 16 are separate structures, which are independent of each other.

In conjunction with FIG. 7 to 9, the main body 1 further includes a perching frame 17. The perching frame 17 is located at the front side of the feeding tray 11 and configured to allow the birds to perch for feeding.

The perching frame 17 is provided with one or more expansion plates 18, a plurality of installation holes are formed in the expansion plate 18 and configured to detachably install feeding devices, which include, but are not limited to, honey pots, fixing spikes, food cages and the like.

In one or more embodiments, the expansion plate 18 is detachably connected with the perching frame 17. After the user removes the expansion plate 18, the perching frame 17 can accommodate a larger number of birds feeding simultaneously. In some embodiments, the expansion plate 18 is connected with the perching frame 17 via snap connection or magnetic connection. However, in other embodiments, the expansion plate 18 is placed on the perching frame 17 and provided with a limiting structure 180 matched with the perching frame 17 in a limiting manner. In this case, the perching frame 17 includes an arc-shaped rib 171 and a connecting rib 172. Extension ribs 173, which are bent inward and extend, are respectively arrange at two ends of the arc-shaped rib 171. The extension ribs 173 are connected with the feeding tray 11, the connecting rib 172 is located below the arc-shaped rib 171, one end of the connecting rib 172 is connected to the arc-shaped rib 171, and the other end of the connecting rib 172 is connected to the feeding tray 11. The connecting rib 172 is arc-shaped, and one end of the connecting rib 172 connected to the arc-shaped rib 171 is arranged higher than the other end of the connecting rib. One end of the expansion plate 18 close to the feeding tray 11 has a first edge 184 protruding toward the main body 1, an area of the feeding tray 11 close to the expansion plate 184 has a second edge 112 protruding outward, and the first edge 184 is located below the second edge 112. As shown in FIG. 8 to FIG. 10, the limiting structure 180 includes a first limiting groove 182 matched with the connecting rib 172 and a second limiting groove 183 matched with the arc-shaped rib 171, where the second limiting groove 183 is formed by bending and extending an outer edge of the expansion plate 181 downward and inward.

Since the connecting rib 172 is arc-shaped, and the end of the connecting rib 172 connected to the arc-shaped rib 171 is higher than the end connected to the feeding tray 11, the weight of the expansion plate 18 gives it a gravitational potential energy to move toward the feeding tray 11. In this way, the risk of the expansion plate 18 accidentally detached from the perching frame 17 can be effectively reduced. When removing the expansion plate 18 from the perching frame 17 is needed, the user needs to move the expansion plate 18 in a direction away from the feeding tray 11 for a short distance, so that the first edge 184 exits the area below the second edge 112, and then the expansion plate 18 is removed, which may further greatly prevent the expanding plate 18 from being unintentionally detached from the perching frame 17.

In some embodiments, in conjunction with FIG. 6 to FIG. 8, the perching frame 17 is detachably connected with the feeding tray 11, which may facilitate the transportation and cleaning of the bird feeder. Specifically, an insertion hole for an end of the extension rib 173 to insert is formed in the feeding tray 11. The perching frame 17 further includes an embedding block 174, where one end of the connecting rib 172 away from the arc-shaped rib 171 is connected to the embedding block174. An embedding groove 113 matched with the embedding block 174 is formed in the feeding tray 11. In more detail, the perching frame 17 is made of metal or plastic, and thus has a certain degree of elasticity. Therefore, the perching frame 17 may be stably fixed on the feeding tray 11 through cooperation of the embedding block 174 and the embedding groove 113 and cooperation of the extension rib 173 and the insertion hole 114.

The above-mentioned descriptions are only embodiments of the present application, and are not intended to limit the patent scope of the present disclosure. Any equivalent modifications made by using the contents of the specification and accompanying drawings of the present disclosure, or direct or indirect applications in related technical fields are similarly included in the patent protection scope of the present application.

What is claimed is:

1. A bird feeder, comprising:
a main body, comprising a feeding tray; and
a first shooting device, wherein a vacant area is formed between the first shooting device and the feeding tray, and the vacant area prevents birds from perching between the first shooting device and the feeding tray.

2. The bird feeder according to claim 1, wherein the feeding tray is U-shaped, and the vacant area is located at an inner side of the feeding tray.

3. The bird feeder according to claim 1, wherein the main body further comprises a feed bin connected with the feeding tray, and the feed bin and the feeding tray enclose the vacant area.

4. The bird feeder according to claim 3, wherein the feed bin is provided with an avoidance area for accommodating the first shooting device.

5. The bird feeder according to claim 4, wherein the avoidance area runs through a front side and a rear side of the feed bin.

6. The bird feeder according to claim 5, wherein a bottom of the avoidance area is communicated with the vacant area.

7. The bird feeder according to claim 6, wherein the feed bin is provided with feed channels, both ends of the feeding tray are respectively connected to the feed channels, and the feeding tray and the two feed channels enclose the avoidance area and the vacant area.

8. The bird feeder according to claim 7, wherein the feed bin is provided with a storage portion communicated with the feed channels, and the storage portion is located above the avoidance area.

9. The bird feeder according to claim 4, further comprising a fixing bracket connected with the main body, wherein the fixing bracket is provided with a fixing plate extending into the avoidance area, and the first shooting device is installed on the fixing plate.

10. The bird feeder according to claim 9, wherein the fixing bracket further comprises legs connected with the fixing plate, the legs are connected with the main body and cause the feed bin and the feeding tray to be inclined, and a support portion is formed at the bottom of an area of the feeding tray away from the first shooting device.

11. The bird feeder according to claim 3, wherein an opening is formed in the top of the feed bin, the opening of the feed bin is inclined and has a first side and a second side away from the first side, and the first side is arranged higher than the second side.

12. The bird feeder according to claim 11, wherein a detachable stop plate is provided at the opening of the feed bin, the stop plate covers an area of the opening close to the second side, and an edge of the stop plate close to the first side and the first side enclose a feed inlet.

13. The bird feeder according to claim 12, wherein a notch is formed in an area of the stop plate away from the second side.

14. The bird feeder according to claim 11, further comprising a bin lid rotatably connected with the feed bin, wherein the bin lid is shell-shaped.

15. The bird feeder according to claim 1, wherein the main body further comprises a perching frame, the perching frame is located at a front side of the feeding tray and is provided with an expansion plate, and a plurality of installation holes are formed in the expansion plate.

16. The bird feeder according to claim 15, wherein the expansion plate is detachably connected with the perching frame.

17. The bird feeder according to claim 16, wherein the expansion plate is detachably placed on the perching frame and is provided with a limiting structure matched with the perching frame in a limiting manner, the perching frame comprises an arc-shaped rib and a connecting rib, the connecting rib is located below the arc-shaped rib, one end of the connecting rib is connected to the arc-shaped rib, the other end of the connecting rib is connected to the main body, the limiting structure comprises a first limiting groove matched with the connecting rib and a second limiting groove matched with the arc-shaped rib, and the second limiting groove is formed by bending and extending an outer edge of the expansion plate downward and inward; the connecting rib is arc-shaped, and one end of the connecting rib connected to the arc-shaped rib is arranged higher than the other end of the connecting rib; and one side of the expansion plate close to the feeding tray is provided with a first edge protruding toward a direction of the main body, an area of the feeding tray close to the expansion plate is provided with a second edge protruding outward, and the first edge is located below the second edge.

18. The bird feeder according to claim 1, wherein the first shooting device is a Pan-tilt-zoom (PTZ)-Fixed Linkage Camera.

19. The bird feeder according to claim 1, wherein a distance between the first shooting device and the feeding tray is greater than or equal to 80mm in a shooting direction of the first shooting device.

20. The bird feeder according to claim 1, further comprising a second shooting device, wherein the second shooting device is arranged at a side of the feeding tray and shoots from the side of the feeding tray towards the feeding tray.
